(19) United States
(12) Patent Application Publication
(10) Pub. No.: US 2010/0129661 A1
(43) Pub. Date: May 27, 2010

(54) COATING COMPOUND FOR PORTABLE ELECTRONIC APPARATUS AND COATING METHOD FOR THE PORTABLE ELECTRONIC APPARATUS

(75) Inventors: Hyun-Jung JUNG, Seoul (KR); Hoon-Soo PARK, Gyeonggi-do (KR); Shin-Chul KANG, Seoul (KR); Dong-Hyeon HWANG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/603,898

(22) Filed: Oct. 22, 2009

(30) Foreign Application Priority Data
Nov. 24, 2008 (KR) 10-2008-0117100

(51) Int. Cl. B32B 27/08; B05D 7/24; C09D 155/02; C09D 167/00; C09D 7/12

(52) U.S. Cl. 428/412; 427/58; 524/571; 524/599; 106/287.25; 106/287.24

(57) ABSTRACT

A coating compound and method for a portable electronic apparatus having frequent contact with users, such as a portable terminal, a Portable Multimedia Player (PMP), a Personal Digital Assistant (PDA), or the like. A housing of the portable electronic apparatus has the coating compound coated arranged thereon, and a bead portion is blended and added to the coating compound prior to applying the coating compound onto the housing so that convexes and concaves are formed on and in an outer surface of the housing by the bead portion. The coating method includes manufacturing a housing of the portable electronic apparatus by injection, coating the coating compound onto the manufactured housing, and drying the coating compound coated onto the housing so that particles of acrylic beads and urethane beads included in the coating compound protrude from an outer surface of the housing.

### CLAIM OF PRIORITY

This application claims the benefit under 35 U.S.C. §119(a) from a Korean Patent Application filed in the Korean Intellectual Property Office on Nov. 24, 2008 and assigned Serial No. 2008-0117100, the entire disclosure of which is hereby incorporated by reference in its entirety.

### BACKGROUND OF THE INVENTION

1. Field of the Invention

The present invention relates to a coating compound for a portable electronic apparatus and a coating method for the portable electronic apparatus. More particularly, the present invention relates to a coating compound for a housing of an portable electronic apparatus having frequent contact with users, such as a portable terminal, a Portable Multimedia Player (PMP), a Personal Digital Assistant (PDA), or the like, and a coating method for same.

2. Description of the Related Art

Generally, portable electronic apparatuses, such as portable terminals, MP3 players, Portable Multimedia Players (PMPs), Personal Digital Assistants (PDAs), and so forth, allow users to enjoy various contents while moving around on foot, bicycle, in motor vehicles, airplanes, boats, etc. Such portable electronic apparatuses are becoming increasingly multifunctional and yet miniaturized to comply with consumers' demands.

In particular, portable terminals refers to electronic apparatuses which enable users to perform wireless communication with other such devices or a network while carrying them around. Typically, portable terminals are classified into several categories, including bar-type portable terminals, flip-type portable terminals, folder-type portable terminals, and sliding-type portable terminals based, the categories being based on how these devices are opened or closed. To enhance portability, such portable terminals are often miniaturized when compared to older versions, so as to facilitate increased portability.

However, as multimedia functions, such as digital multimedia broadcasting (DMB), moving picture file appreciation, and the like, are expanding in functionality and content, the size of the portable terminal is increasing to some extent so that a sufficient size of a display device can be secured to view the content. As a result, the effort in size-reduction of the portable terminal has been focused on reducing an overall thickness of the portable terminal by reducing a thickness of an outer housing of the portable terminal, thereby making the portable terminal slimmer.

To secure shock and abrasion resistances for the slim portable terminal in spite of the small thickness, a housing is made in part of a metal material and another part of the housing is made of a synthetic resin material. The synthetic resin used to make the housing comprises poly carbonate, which is generally deformed at a temperature of about 100° C., and thus the exterior of the housing is coated with a coating material such as urethane resin and then dried at a low temperature of less than 80° C. However, in order to prevent deformation of a synthetic resin part of the housing of the conventional portable terminal, for at least 90 minutes and at most 180 minutes are taken at a low temperature of less than 80° C. after coating, lowering productivity. Moreover, the synthetic resin part of the housing of the conventional portable terminal is easily damaged because of its vulnerability to shock.

With regard to the housing, a coating material used in the housing comprises a waterborne polyurethane resin, a water-soluble chlorinated polyolefin emulsion, a water-soluble polyethylene resin, a waterborne acrylic urethane resin, and so forth. Generally, however, a solvent-based oily resin is normally used in consideration of workability. To represent the texture of the appearance through coating of the housing, glass beads or acrylic beads are used. When either only glass beads or only acrylic beads are used, they generally have an average diameter of 5-8 μm, resulting in degradation of the effect in expressing the texture. Furthermore, two or more coating materials have to be used for texture expression.

Accordingly, there is a long-felt need in the art for a coating compound for a portable electronic apparatus, which makes it possible to express texture with a single coating layer, instead of conventional two or more coating layers, and a coating method for the portable electronic apparatus. There is also a long-felt need in the art for a coating compound for a portable electronic apparatus, which allows expression of vivid metallic texture through diffused reflection brightness by using acrylic beads or urethane beads and also allows expression of a color impression like aluminum sanding, and a coating method for the portable electronic apparatus.

There is also a long-felt need in the art for a coating compound for a portable electronic apparatus, which makes it possible to implement various color impressions according to the mixing composition of the coating compound and to implement tactile expression according to the expression of exterior texture, and a coating method for the portable electronic apparatus, that also permits the apparatus to be able to withstand a certain amount of shock and not crack the coating.

### SUMMARY OF THE INVENTION

An exemplary aspect of the present invention is to provide a coating compound for a portable electronic apparatus, which makes it possible to provide a desired degree of texture with a single coating layer. In addition, a coating method for coating items such as a portable electronic apparatus is described herein.

Another exemplary aspect of the present invention is to provide a coating compound for a portable electronic apparatus, which allows expression of vivid metallic texture through diffused reflection brightness by using acrylic beads or urethane beads and also allows expression of a color impression like aluminum sanding, and a coating method for the portable electronic apparatus.

Still another exemplary aspect of the present invention is to provide a coating compound (and coating method) for a portable electronic apparatus that makes it possible to implement various color impressions according to the mixing composition of the coating compound and to implement tactile impressions according to the expression of exterior texture for the portable electronic apparatus.

According to an exemplary aspect of the present invention, there is provided a coating compound for a portable electronic apparatus, which includes a housing and the coating compound coated onto the housing, and in which a bead portion is blended and added to the coating compound and the coating compound is coated onto the housing and then dried, such that convexes and concaves are formed on and in an outer surface of the housing by the bead portion.

According to another exemplary aspect of the present invention, there is provided a coating method for a portable electronic apparatus onto which a coating compound is to be coated, the method including manufacturing a housing of the portable electronic apparatus by injection, coating the coating compound onto the manufactured housing, drying the coating compound coated onto the housing, and allowing particles of acrylic beads and urethane beads included in the coating compound to protrude from an outer surface of the housing.

### BRIEF DESCRIPTION OF THE DRAWINGS

The above and other exemplary features and advantages of an exemplary embodiment of the present invention will be more apparent from the following detailed description taken in conjunction with the accompanying drawings, in which:

FIG. 1 illustrates a state in which a coating compound is coated on a housing according to an exemplary embodiment of the present invention;

FIG. 2 illustrates a state in which the coating compound coated on the housing is dried according to the exemplary embodiment of the present invention;

FIG. 3 illustrates a state in which convexes and concaves are formed on and in an outer surface of the housing by a bead portion according to the exemplary embodiment of the present invention; and

FIG. 4 is a flowchart illustrating a coating method for a portable electronic apparatus according to the exemplary embodiment of the present invention.

### DETAILED DESCRIPTION

Hereinafter, a coating compound for a portable electronic apparatus according to an exemplary embodiment of the present invention will be described in detail with reference to the accompanying drawings. Descriptions of well-known functions and constructions may be omitted for clarity and conciseness when their inclusion may obscure appreciation of the claimed subject matter by a person of ordinary skill in the art. In addition, like reference numerals are generally used to refer to like components having the same functions as conventional functions.

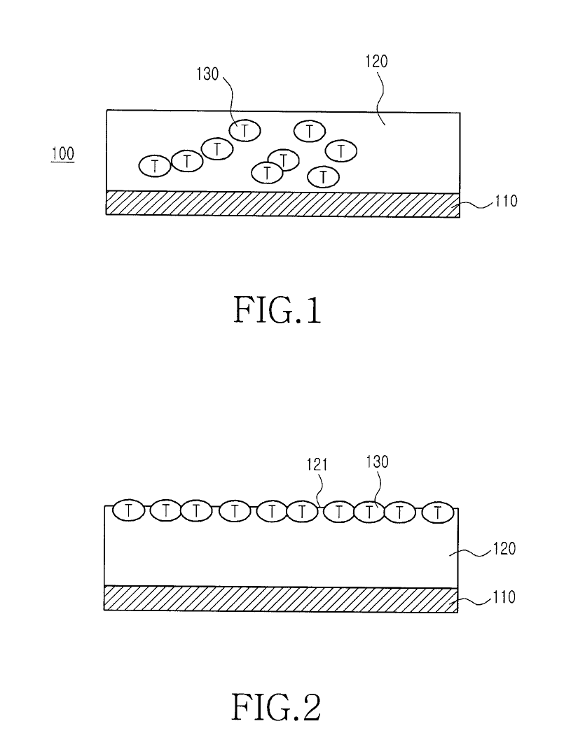

As shown in the examples in FIGS. 1 through 3, the portable electronic apparatus 100 includes a housing 110 and a coating compound 120 to which a bead portion 130 is blended and added. The housing 110 is preferably manufactured by injection. The coating compound 120 is preferably coated onto the housing 110 as a single layer. As the coating compound 120 is coated onto the housing 110 and then dried, the bead portion 130 gathers toward an outer surface of the coating compound 120, thus forming convexes and concaves on and in a surface of the housing 110.

As shown in the examples in FIGS. 1 through 3, if the housing 110 is injection-manufactured with polycarbonate (PC), which is a plastic material, and acrylonitrile-butadiene-styrene (ABS) resin, a single coating layer is formed by applying the coating compound 120 onto the outer surface of the housing 110. Since the bead portion 130 is blended and added to the coating compound 120, uniform texture can be acquired on the outer surface of the housing 110 even if the coating compound 120 is applied as a single layer.

As shown in FIGS. 1 through 3, if the housing 110 includes a metal member, including but in no way limited to magnesium (Mg), aluminium (Al), stainless steel (STS), a primer layer for improving adherence or color matching between the housing 110 and the coating compound 120 is further coated. If the housing 110 is injection-manufactured with a compound of polycarbonate, which is a plastic material, and glassfiber (PC+GF) or polyphthalmide (PPA) for superior physical properties such as shock resistance in spite of small thickness, the primer layer for improving adherence or color matching between the housing 110 and the coating compound 120 is further coated.

According to an exemplary aspect of the present invention, the coating compound 120 preferably includes at least one or more of polyester polyol, urethane polyol, polybutadiene polyol, and acrylic polyol.

In addition, the preferable content of the coating compound 120 is substantially 40 to 50% by weight (or wt %).

Moreover, the coating compound 120 further preferably substantially includes: 0 to 10 wt % of aluminium paste, 0 to 10 wt % of pearl pigment, 0 to 10 wt % of an additive, and 0 to 10 wt % of a color pigment.

According to another exemplary aspect of the present invention, the coating compound 120 is applied in a state of being included in a solvent. The solvent is prepared by mixing at least two or more, preferably two to four, of xylene, toluene, methanol, ethanol, isoprophylene alcohol, isobutyl alcohol, methyl isobutyl ketone, methyl ethyl ketone, cyclohexanone, ethyl acetate, and butyl acetate. The content of the solvent is substantially 20 to 50% by weight. The bead portion 130 is made by blending acrylic beads and urethane beads. By coating the coating compound 120 onto the housing 110 and then drying it, the particles of the acrylic beads and the urethane beads that were added to the coating compound 120 protrude from the outer surface of the housing 110, thus forming a plurality of convex and concave surfaces. The acrylic beads and the urethane beads are generally formed to have a size of about 5 to 20 μm in consideration of spray-line workability and mass production during application of the coating compound 120 onto the housing 110, and are added to the coating compound 120 preferably after being blended. The acrylic beads and the urethane beads have different textures and chemical physical properties, and thus a composition ratio thereof may vary with the extent to which their physical properties are secured.

With reference to FIGS. 1 through 3, a more detailed description will now be made of the coating compound 120 for the portable electronic apparatus according to an exemplary embodiment of the present invention.

As shown in FIG. 1, the coating compound 120 is applied onto the housing 110 of the portable electronic apparatus. The coating compound 120 includes at least one or more of, for example, polyester polyol, urethane polyol, polybutadiene polyol, and acrylic polyol, and the content thereof is 40 to 50% by weight. When the coating compound 120 is applied onto the housing 110, it may further include substantially about: 0 to 10 wt % of aluminium paste, 0 to 10 wt % of pearl pigment, 0 to 10 wt % of an additive, and 0 to 10 wt % of a color pigment to represent metallic texture of the housing 110. The coating compound 120 is coated onto the housing 110 in a state of being included in the solvent which is prepared by mixing at least two or more of xylene, toluene, methanol, ethanol, isoprophylene alcohol, isobutyl alcohol, methyl isobutyl ketone, methyl ethyl ketone, cyclohexanone, ethyl acetate, and butyl acetate. The preferable content of the solvent is 20 to 50% by weight. The acrylic urethane beads 130 are blended together and added to the coating compound 120 such that colors which are vivid and represent a metallic texture through diffused reflection brightness can be expressed and natural, mineral, warm, and organic impressions can be expressed. The acrylic beads and the urethane beads generally have a size of about 5 to 20 μm in consideration of spray-line workability and mass production during coating of the coating compound 120 onto the housing 110. These acrylic and urethane beads 130 are added to the coating compound 120 according to their colors and tactile impressions. The acrylic beads and the urethane beads have different textures and chemical physical properties, and thus a composition ratio thereof may vary with the extent to which their physical properties are secured. Accordingly, the coating compound 120 including the foregoing components is applied (coated) onto the injection-manufactured housing 110 and then dried.

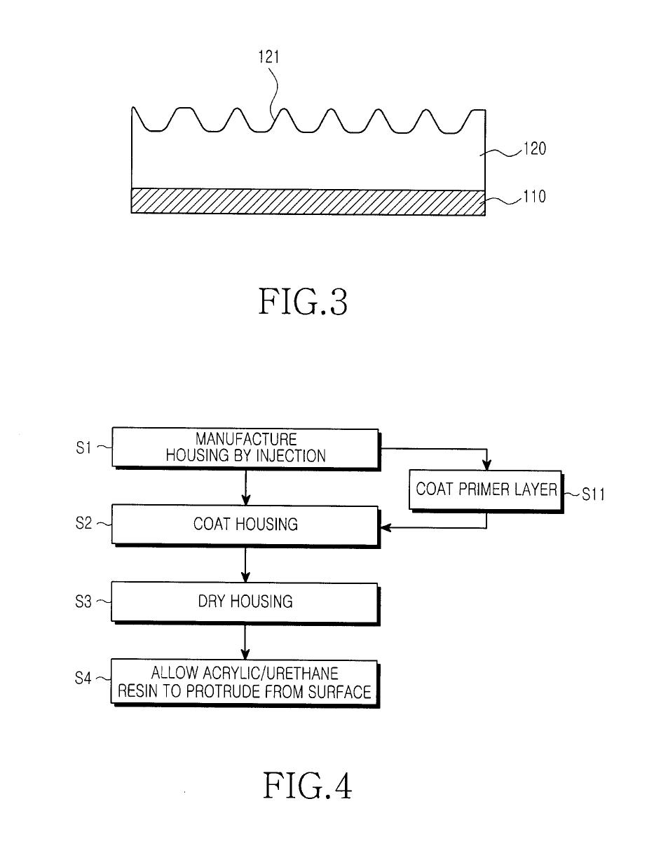

As shown in FIG. 2, as the coating compound 120 is dried, the urethane beads 130 and the acrylic beads 130 gather while protruding from the outer surface of the coating compound 120. As a result, when the coating compound 120 is completely dried, convexes and concaves (i.e. convex and concave surfaces) are formed on and in the outer surface of the housing 110 as shown in FIG. 3, thus forming a texture on the outer surface of the housing 110.

With reference to the accompanying drawings, a detailed description will now be made of a coating method for the portable electronic apparatus according to the exemplary embodiment of the present invention.

Exemplary operation of the method of coating according to the present invention is shown in the flowchart of FIG. 4. The coating method includes step S1 of manufacturing the housing 110 for the portable electronic apparatus by injection, step S2 of coating an exterior of the injection-manufactured housing 110, step S3 of drying the coating compound 120 coated onto the housing 110, and step S4 in which particles of acrylic/urethane beads included in the coating compound 120 protrude from the outer surface of the housing 110.

According to an exemplary aspect of the present invention, if the housing 110 is manufactured with polycarbonate (PC) and acrylonitrile-butadiene-styrene (ABS) resin, the coating compound 120 is directly coated onto the outer surface of the housing 110.

According to another exemplary aspect of the present invention if the housing 110 includes a metal member, a compound of polycarbonate and glassfiber (PC+GF), or polyphthalamide (PPA) in step S1, then as shown in FIG. 4, step S11 of coating a primer layer for improving adherence or color matching between the housing 110 and the coating compound 120 is further provided.

According to the present invention, the coating compound 120 includes at least one or more of polyester polyol, urethane polyol, polybutadiene polyol, and acrylic polyol. The preferable content of the coating compound 120 is 40 to 50% by weight. The coating compound 120 preferably includes 0 to 10 wt % of aluminium paste, 0 to 10 wt % of pearl pigment, 0 to 10 wt % of an additive, and 0 to 10 wt % of a color pigment, and the coating compound 120 is applied in a state of being included in a solvent prepared by mixing at least two or more of xylene, toluene, methanol, ethanol, isopropylene alcohol, isobutyl alcohol, methyl isobutyl ketone, methyl ethyl ketone, cyclohexanone, ethyl acetate, and butyl acetate.

Moreover, according to the present invention, the acrylic beads and the urethane beads are blended and added to the coating compound 120 prior to the coating compound 120 being applied and then dried, so that the particles of the acrylic beads and the urethane beads protrude from the outer surface of the housing 110 to form convexes and concaves.

Accordingly, according to the present invention a single coating layer is coated onto the housing of the portable electronic apparatus to impart texture, thereby providing visual and tactile properties and improving aesthetic quality. Moreover, by forming a desired texture on the outer surface of the housing with single coating, the manufacturing costs can be reduced. Furthermore, the elegance of the portable electronic apparatus can be acquired by applying the coating compound onto a portion of the housing to which a metal material is difficult to apply.

As is apparent from the foregoing description, according to the present invention, texture can be expressed with a single coating layer, thereby simplifying an assembly process and cutting down the cost of materials.

Moreover, according to the present invention, by adding acrylic beads or urethane beads to the coating compound, vivid metallic texture can be expressed through diffused reflection brightness and a color impression like aluminum sanding can be achieved, thereby making the exterior design of the portable electronic apparatus more sophisticated and improving the aesthetic quality of the portable electronic apparatus.

Furthermore, various color impressions can be provided according to the mixing composition of the coating compound and tactile expression can be implemented according to the expression of the exterior texture, thereby providing a more agreeable touch to users and unifying the exterior design of the portable electronic apparatus with metallic texture.

While the coating compound for the portable electronic apparatus and the coating method for the portable electronic apparatus according to the present invention have been shown and described with reference to exemplary embodiments thereof, it will be understood by those skilled in the art that various changes in form and details may be made therein without departing from the spirit and scope of the invention as defined by the appended claims.

What is claimed is:

1. A coating compound suitable for a housing of a portable electronic apparatus in which the coating compound is coated onto a housing, said coating compound further includes:
a bead portion being blended with the coating compound to form convex and concave shapes on and in an outer surface of the coating compound when said coating compound is dried.

2. The coating compound according to claim 1, comprising at least one or more of polyester polyol, urethane polyol, polybutadiene polyol, and acrylic polyol

3. The coating compound according to claim 1, wherein the coating compound includes a polyol compound selected from the group consisting of polyester polyol, urethane polyol, polybutadiene polyol, and acrylic polyol.

4. The coating compound according to claim 2, wherein the bead portion is blended with the polyol compound.

5. The coating compound according to claim 1, wherein the content of the coating compound is 40 to 50% by weight (wt %).

6. The coating compound according to claim 2, wherein the content of the coating compound is 40 to 50% by weight (wt %).

7. The coating compound of claim 5, wherein the coating compound further comprises 0 to 10 wt % of aluminium paste, 0 to 10 wt % of pearl pigment, 0 to 10 wt % of an additive, and 0 to 10 wt % of a color pigment.

8. The coating compound of claim 1, further comprising said coating compound being mixed with a solvent.

9. The coating compound of claim 8, wherein the solvent comprises two or more of xylene, toluene, methanol, ethanol, isoprophylene alcohol, isobutyl alcohol, methyl isobutyl ketone, methyl ethyl ketone, cyclohexanone, ethyl acetate, and butyl acetate.

10. A housing for a portable terminal including the coating compound of claim 1, wherein the housing comprises a polycarbonate (PC) and a acrylonitrile-butadiene-styrene (ABS) resin, and the coating compound is coated onto an outer surface of the housing as a single layer.

11. The housing for a portable terminal of claim 10, wherein the housing further includes at least one of a metal member, a compound of polycarbonate and glassfiber (PC+GF), or a polyphthalmide (PPA), and
a primer layer for adherence and color matching is arranged between the housing and the coating compound.

12. The housing for a portable terminal of claim 11, wherein the coating compound comprises at least one or more of polyester polyol, urethane polyol, polybutadiene polyol, and acrylic polyol.

13. The coating compound of claim 9, wherein the coating compound comprises at least one or more of polyester polyol, urethane polyol, polybutadiene polyol, and acrylic polyol.

14. The coating compound of claim 9, wherein the content of the coating compound is 40 to 50 by weight (wt %).

15. The coating compound of claim 14, wherein the coating compound further comprises 0 to 10 wt % of aluminium paste, 0 to 10 wt % of pearl pigment, 0 to 10 wt % of an additive, and 0 to 10 wt % of a color pigment.

16. The coating compound of claim 15, wherein prior to application on the housing, the coating compound includes a solvent comprising a mixture of at least two or more of xylene, toluene, methanol, ethanol, isoprophylene alcohol, isobutyl alcohol, methyl isobutyl ketone, methyl ethyl ketone, cyclohexanone, ethyl acetate, and butyl acetate.

17. The coating compound of claim 16, wherein the content of the solvent is 20 to 50 wt %.

18. The coating compound of claim 1, wherein the bead portion is formed of blended acrylic beads and urethane beads with the coating compound such that particles of the acrylic beads and the urethane beads protrude from the outer surface of the coating compound to form the convex and the concave shapes when the coating compound is dried.

19. The housing for a portable terminal of claim 10, wherein the bead portion is formed of blended acrylic beads and urethane beads such that particles of the acrylic beads and the urethane beads protrude from the outer surface of the housing to form the convex and the concave shapes when the coating compound is dried.

20. A coating method for a portable electronic apparatus onto which a coating compound including particles of acrylic beads and urethane beads in the coating compound is to be applied, the coating method comprising:
manufacturing a housing of the portable electronic apparatus by injection molding;
applying the coating compound onto the manufactured housing;
drying the coating compound coated onto the housing so that
particles of acrylic beads and urethane beads included in the coating compound protrude from an outer surface of the housing.

21. The coating method of claim 20, wherein the housing comprises polycarbonate (PC) and acrylonitrile-butadiene-styrene (ABS) resin, and the coating compound is coated onto the outer surface of the housing as a single layer.

22. The coating method of claim 20, wherein the housing further comprises a metal member, a compound of polycarbonate and glassfiber (PC+GF), or polyphthalmide (PPA), and further comprising the step of coating a primer layer for adherence and color matching between the housing and the coating compound.

23. The coating method of claim 22, wherein the coating compound comprises at least one or more of polyester polyol, urethane polyol, polybutadiene polyol, and acrylic polyol, and the content of the coating compound is 40 to 50 by weight (wt %).

24. The coating method of claim 20, wherein the coating compound further comprises 0 to 10 wt % of aluminium paste, 0 to 10 wt % of pearl pigment, 0 to 10 wt % of an additive, and 0 to 10 wt % of a color pigment, and the coating compound mixed with a solvent prior to being applied to the housing.

25. The coating method of 24, wherein the solvent comprises a mix of at least two or more of xylene, toluene, methanol, ethanol, isoprophylene alcohol, isobutyl alcohol, methyl isobutyl ketone, methyl ethyl ketone, cyclohexanone, ethyl acetate, and butyl acetate.

26. The coating method of claim 20, wherein the bead portion is made by blending acrylic beads and urethane beads and the coating compound is coated and then dried, such that particles of the acrylic beads and the urethane beads protrude from the outer surface of the housing to form convexes and concaves on the outer surface.
